(19) United States
(12) Patent Application Publication
(10) Pub. No.: US 2006/0210133 A1
(43) Pub. Date: Sep. 21, 2006

(54) Performance adjustments in medical decision support systems

(76) Inventors: Sriram Krishnan, Exton, PA (US); Murat Dundar, Malvern, PA (US); R. Bharat Rao, Berwyn, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/362,238

(22) Filed: Feb. 24, 2006

Related U.S. Application Data
(60) Provisional application No. 60/658,416, filed on Mar. 3, 2005.

(51) Int. Cl. G06K 9/00

(52) U.S. Cl. 382/128; 128/920; 128/922

(57) ABSTRACT

A user adjusts the performance for assisted diagnosis. The sensitivity, specificity or both are adjusted as desired by the physician or end-user. By adjusting the trade-offs, a decision support system may be optimized by each user or for each case, possibly avoiding a one-fits-all approach or requiring purchase of different CAD products.

### RELATED APPLICATIONS

The present patent document claims the benefit of the filing date under 35 U.S.C. §119(e) of Provisional U.S. Patent Application Ser. No. 60/658,416, filed Mar. 3, 2005, the disclosure of which is hereby incorporated by reference.

### BACKGROUND

The present embodiments relate to medical decision support systems. Classifiers use machine learning or other algorithms to provide decision support for physicians. For example, computer assisted diagnosis (CAD) devices for mammography detection use classifiers to help identify potential lesions or calcifications in the breast.

Classification systems trade-off between sensitivity and specificity. Most classification systems are characterized by a receiver operating characteristic (ROC), usually displayed as a curve. FIG. 1 shows an ROC curve. The ROC curve shows the trade-off between sensitivity (the true positive fraction) against specificity (the true negative fraction). The horizontal axis, specificity, is displayed as 1-specificity. An optimum performance would have a specificity of 1 (0 on the horizontal axis) and a sensitivity of 1. However, CAD systems may not be able to achieve optimum performance. Instead, a designer sets the operating point of the system such that a desired specificity or sensitivity is satisfied but not necessarily both.

Systems that employ classifiers are judged based on the ROC curve, or values derived from this curve, such as the area under the curve. When employed within a product for use by physicians in a clinical or medical environment, the classifier is “fixed” at one point of this curve (i.e., the operating point). This point is often selected to optimize the trade-off of sensitivity and specificity for the specific clinical application. For example, a mammography CAD system tries to identify suspicious lesions and classification marks in a screening mammogram. The emphasis is to find every suspicious lesion. It is more important in this case for the CAD system to find the lesions than to eliminate false negatives. Such a system may fix its classifier to operate towards the right side of the curve, emphasizing sensitivity over specificity.

In an alternative approach to designing classifiers, penalties are adjusted for being incorrect. For example, a decision support system may be called upon to assist the physician in deciding whether to perform a biopsy on a patient. This may be done, for example, by having the CAD system label each suspicious lesion using a Bi-RADS score from 1 to 5, where a score of 4 or 5 suggests that the lesion may be malignant. The user may judge that the penalty for assessing a malignant lesion as benign is worse than the penalty for assessing a benign lesion as malignant. A “penalty table” is created, such as the following:

TABLE 1
Sample penalty table for breast cancer diagnosis

Pathology result

| | | malignant | benign |
|---|---|---|---|
| BiRAD | 0 | −1 | −1 |
| | 1 | −3 | 0 |
| | 2 | −3 | 0 |
| | 3 | −2 | 0 |
| | 4 | 0 | −1 |
| | 5 | 0 | −2 |

The relative penalty for assigning a malignant lesion to a benign reading (1 or 2) is higher than the relative penalty for assigning a benign lesion to a malignant reading (4 or 5). Once a penalty table is defined, a classifier is built to optimize labeling weighted by this penalty table. Building the classifier with, in part, the penalty table alters sensitivity and/or specificity. The penalty table emphasizes or de-emphasizes the effect of particular errors. However, the penalty table may afford more flexibility in optimizing classification performance.

Identifying the point on the ROC curve or developing a penalty table is performed during design or before use of the classifier in a product. The developer of a CAD application predicts what the optimal trade-offs should be for a particular clinical application or product. The classifier is then fixed. Some developers may offer different classifiers with different performance for sale, but a purchaser must predict which classifier is best or purchase multiple separate classifiers.

### BRIEF SUMMARY

By way of introduction, the preferred embodiments described below include methods, systems, and instructions for user adjustment of the performance. The sensitivity or specificity are adjusted as desired by the physician or end-user. By adjusting the trade-offs, a decision support system may be optimized by each user or for each case, providing flexibility for a same CAD product. The physician may select a desired operating point on a case-by-case basis, possibly avoiding a one-fits-all approach or requiring purchase of different CAD products.

In a first aspect, a method is provided for adjusting performance in a medical decision support system. During assisted diagnosis, user input of a specificity, sensitivity or specificity and sensitivity related performance parameter is received. During the assisted diagnosis, a classifier is determined as a function of the performance parameter. The classifier is applied during the assisted diagnosis.

In a second aspect, a computer readable storage media has stored therein data representing instructions executable by a programmed processor for adjusting performance in a medical decision support system. The instructions are for displaying an option for setting performance, receiving user input of a specificity, sensitivity or specificity and sensitivity related performance, obtaining a classifier as a function of the performance, and applying the classifier.

In a third aspect, a system is provided for adjusting performance in a medical decision support. A user input is operable to receive different performance settings at different times. A processor is operable to determine a first classifier as a function of a first performance setting, operable to determine a second classifier as a function of a second performance setting and operable to determine a first diagnosis with the first classifier and a second diagnosis with the second classifier. The processor is part of a medical decision support system.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is an example receiver operation characteristic (ROC) curve;

FIG. 2 is a block diagram of one embodiment of a system for adjusting performance in a medical decision support;

FIG. 3 illustrates example ROC curves for two classifiers; and

FIG. 4 is a flow chart diagram showing one embodiment of a method for adjusting performance in a medical decision support.

### DETAILED DESCRIPTION OF THE DRAWINGS AND PRESENTLY PREFERRED EMBODIMENTS

A clinician rather than the application developer may be the better judge for where the sensitivity and specificity trade-offs should be made in a classifier. The optimum performance may be different for different patients, end-users or facilities. A system incorporates a classifier allowing the user to adjust the performance, such as adjusting the trade-off between sensitivity and specificity. Rather than building one classifier for a system with a “fixed” trade-off for each clinical situation, the performance is alterable. For example, a bank of classifiers associated with different performances is provided for user selection. As another example, the classifier is constructed under the control of the end-user and as a function of a desired performance. In another example, a threshold for a probability output by a classifier is adjusted to alter the performance.

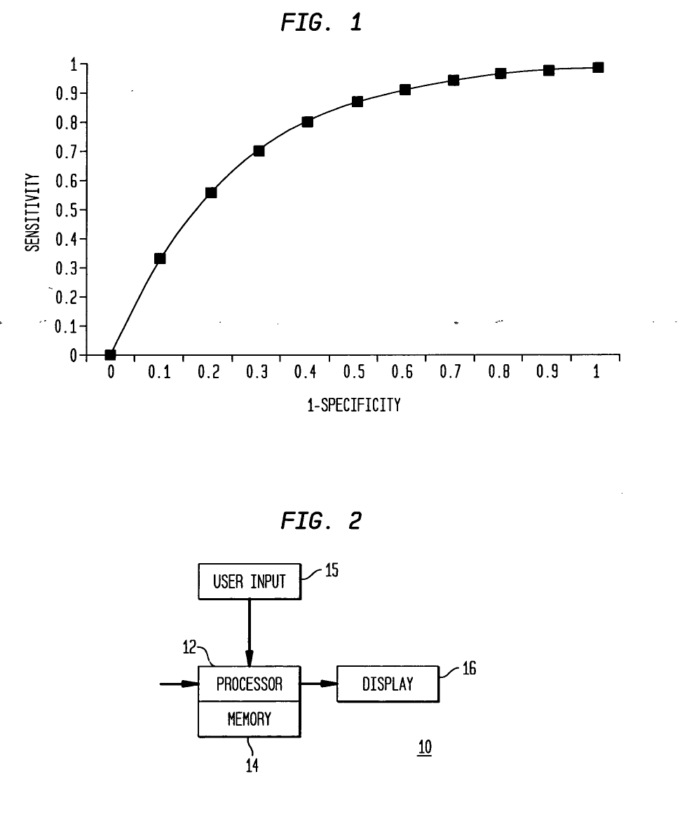

FIG. 1 shows a system 10 for adjusting performance in a medical decision support. The system 10 includes a processor 12, a memory 14, a user input 15 and a display 16. Additional, different or fewer components may be provided. The system 10 is a personal computer, workstation, medical diagnostic imaging system, network, or other now known or later developed system for providing decision support. For example, the system 10 is a computer aided diagnosis system. Automated assistance is provided to a physician or clinician for classifying a state appropriate for given medical information, such as the records of a patient. Assistance is provided for diagnosis of heart diseases, breast cancer, and/or lung cancer, but diagnosis may be performed for other medical abnormalities, such as associated with other organs. The automated assistance is provided after subscription to a third party service, purchase of the system 10, purchase of software or payment of a usage fee.

The user input 15 is a mouse, keyboard, switch, buttons, key, slider, knob, touch pad, touch screen, trackball, combinations thereof or other now known or later developed user input device. The user input 15 receives input from a user. In response to activation of the user input 15, signals or data are provided to the processor 12.

The user input 15 receives a performance setting from a user. The performance setting may correspond with a numerical value, a relative setting, a scale, a textual selection (e.g., “emphasize sensitivity”) or other display. For example, a sliding bar or rotating knob allows the user to adjust between sensitivity and specificity. As another example, the user may position a cursor along an ROC curve. The user input 15 receives a relative setting of sensitivity and specificity as the performance setting. Moving the slider, knob or cursor in one direction increases sensitivity and decreases specificity. Moving in the opposite direction increases specificity and decreases sensitivity. Alternatively, the user specifies, for example, the desired sensitivity (or specificity) of the system 10. The desired sensitivity and/or specificity may be a percentage, or may be in other terms, such as the maximum number of false positives allowed per image. Alternatively, the user sets values in a table, such as the penalty values in Table 1, or the user selects between different available tables or textual descriptions of the relative effects of tables. The user input is solicited by a display on the display 16 as part of a user interface. Alternatively, the user operates the user input 15 based on knowledge, a print out or other information.

Different performance settings may be received at different times. For example, the user changes performance settings during a same diagnosis session for a same patient. A diagnosis session corresponds to use of the system 10 to diagnose a patient. The session may include iterative classification with the system 10 for each performance setting. Multiple settings may be used to achieve a desired output, for comparison of outputs pursuant to different performance settings, or for different users consulting on the diagnosis. In another example, the different performance settings are changed for use analyzing different patients. A different emphasis in performance may be desired for different patients or by different users. By allowing the user to adjust the performance of the classifier, the system 10 may be optimized for performance as judged by the clinical user at the time of use or during a diagnosis session, rather than relying only on an a-priori decisions by a developer regarding trade-offs in performance.

The processor 12 is a general processor, digital signal processor, application specific integrated circuit, field programmable gate array, analog circuit, digital circuit, combinations thereof or other now known or later developed processor. The processor 12 may be a single device or a combination of devices, such as associated with a network or distributed processing. Any of various processing strategies may be used, such as multi-processing, multi-tasking, parallel processing or the like. The processor 12 is responsive to instructions stored as part of software, hardware, integrated circuits, film-ware, micro-code or the like.

The processor 12 is part of the medical decision support system 10. The medical decision support system 10 is provided for use by clinicians or physicians, rather than being a workstation or computer for developing a classifier to be incorporated into medical decisions support systems. The processor 12 is located at the medical facility, but may be at a remote location, such as being connected over a network. The processor 12 operates for assisting diagnosis of new or current patients. In alternative embodiments, the processor 12 is part of a developers system.

The processor 12 determines a classifier as a function of the received performance setting. When the performance setting is changed or different setting is received, the processor 12 determines another classifier as a function of the new performance setting. The processor 12 determines the different classifiers during the same diagnosis session for the patient or during different diagnosis sessions, such as for different patients.

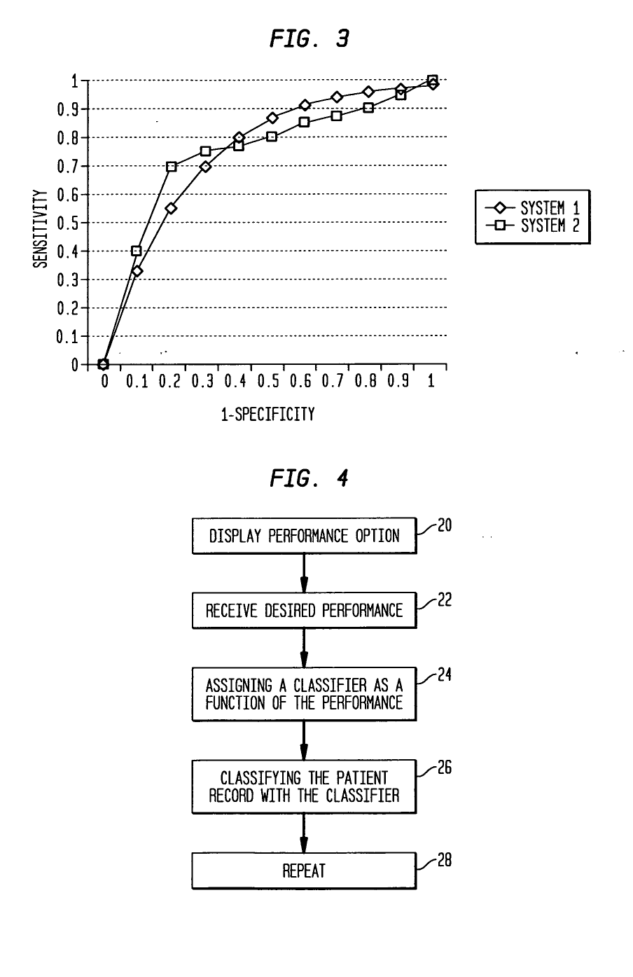

Any technique for determining the classifier as a function of the performance setting may be used. In one embodiment, the processor 12 determines classifiers by selecting from a collection of classifiers. A bank of classifiers associated with different performance is pre computed and stored. The processor 12 determines the classifier with the performance most closely matching the desired performance. Where multiple classifiers qualify, the one with the most optimum sub-performance is selected, such as selecting a highest specificity from two classifiers meeting a desired sensitivity performance. The different classifiers may be optimized for different needs. For example, FIG. 3 shows two classifiers with different ROC curves. If specificity is very important, but sensitivity only need be around 70%, then the classifier System 2 may be better. However, if sensitivity is more important, and the sensitivity needs to be around 90% while maximizing specificity, then the classifier System 1 may be better. The classifier applied to a patient record is optimized to a desired performance by the user.

In another embodiment, the classifier is determined by constructing the classifier from training data. The training data includes patient records for a desired clinical diagnosis, such as patient records for breast cancer. Each of the patient records in the training set includes a plurality of features, such as test results, billing codes, image extracted features, age, family history or any other feature. The patient records are labeled, such as a binary yes/no label, a multilevel label (e.g., BiRAD), or other truth label. Different types of classifiers may be available, such as support-vector machine (SVM), decision tree, neural net, Bayesian classifier, or combinations thereof.

The classifier is constructed as a function of the desired performance. Different feature combinations, different types of classifiers, and/or different tuning are used to build a classifier meeting the desired performance. The processor 12 iteratively develops the classifier. The approach used to build the classifier is varied to identify a classifier with the desired performance. The automatic process may be through a programmed search pattern or guided with a knowledge base. For example, a knowledge base may indicate features, types or tuning more likely to result in a classifier meeting a particular performance.

The processor 12 estimates performance of each classifier. For example, the processor 12 calculates a ROC curve, specificity, sensitivity or other parameter. The training data is used to determine the performance, such as using a leave one out approach. The first constructed classifier may satisfy the desired performance. Alternatively, additional classifiers are constructed. Where the performance may be unsatisfactory, such as a low specificity or sensitivity, the processor 12 constructs a different classifier. For example, additional iterations of training may be provided to determine a more optimum type of classifier and/or set of features for training. The set of features, type of classifier and/or tuning may be altered.

Different classifiers are constructed for different performance settings. The same training set or a different training set is used for the different classifiers. One classifier may meet different performance settings, avoiding additional construction. The different classifiers are provided for a different or same patient, clinician, diagnosis session, or medical facility. For example, the classifier is constructed for each instance of a new patient record to be analyzed or only where another available classifier does not have a desired performance. As another example, the classifier is constructed to assist in a single diagnosis, such as where the clinician desires different types of decision support assistance. The classifier may be developed in minutes or hours. A customer or user of the system 10 uses the development of different classifiers rather than purchasing different classifiers based on an expected need.

In another embodiment, the processor 12 determines classifiers by adjusting one or more thresholds. A different classifier is provided by changing one or more thresholds or variables. The same or different underlying classifier is used. Any now known or later developed variable altering performance may be used. In one embodiment, the classifier determines a probability as an output. A threshold is applied to determine whether the output probability is labeled and provided to the user as possible cancer or other diagnosis. Lesions with a greater probability are identified to the user, and lesions with a lesser probability are not identified to the user. By varying the threshold, such as from 30% or more to a 50% or more probability, the performance changes.

The processor 12, whether a same device or a different device than used to determine the classifier, applies the classifier. The values for the features of the current patient record are input to the classifier. Applying the classifier determines a diagnosis. The classifier outputs a diagnosis, such as a conclusion, probability, location of concern or other information to assist with diagnosis. Different classifiers with the same or different performance may determine a same or different diagnosis of a same patient record. The same or different classifiers may be applied to different patient records.

The memory 14 is a computer readable storage media. Computer readable storage media include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 14 may be a single device or a combination of devices. The memory 14 may be adjacent to, part of, networked with and/or remote from the processor 12.

The memory 14 stores a patient record. The patient record is input manually by the user and/or determined automatically. The patient record may be formatted or unformatted. The patient record resides in or is extracted from different sources or a single source. The patient record includes variables available for a current patient record. The variables correspond to features, such as medical history, pain indication, lump indication, age, genetic information, test results, family history or other sources of information. The patient record may include one or more images of a same or different type. The processor 12, a different processor or the user may extract variables from the image. The variables correspond to features of the image. Any now known or later developed patient record format, features and/or technique to extract features may be used.

In one embodiment, the memory 14 stores a plurality of classifiers. Each classifier may be stored as a matrix, but more complex classifier algorithms, instruction sets, logic, or tools may alternatively or additionally be stored.

Each of the classifiers is a different or same type of classifier. Any now known or later developed classifiers may be used, such as support-vector machine (SVM), decision tree, neural net, Bayesian classifier, or combinations thereof. The classifiers are optimized or designed for classifying with different performance.

A classifier is provided for each possible performance setting. The performance settings are over a range of a single parameter (e.g., sensitivity), over ranges for different parameters (e.g., one range for sensitivity and one range for specificity), or over a range of combinations of parameters (e.g., different combinations of both sensitivity and specificity). Sensitivity and specificity are related to each other and determined by the internal structure of the classifier as represented by the ROC curve. The shape of the ROC curve determines the sensitivity at a given specificity or the specificity at a given sensitivity. Both sensitivity and specificity may be set, but as a trade-off. For example, the user sets both at a desired trade-off along an ROC curve or sets one of these to a desired value and accepts the resulting value for the other. Different classifiers may be provided for different penalty tables. Alternatively, a fewer number of classifiers is provided. The classifier exceeding or more closely meeting the desired performance is selected.

In another embodiment, the memory 12 stores training data. The training data is a collection of two or more previously acquired patient records and corresponding labels or ground truths. For example, hundreds, thousands or tens of thousands of patient records are obtained and stored. In one embodiment, the records are originally created as part of a clinical study. In other embodiments, the records are gathered independent of a clinical study, such as being collected from one or more hospitals.

Each training set patient record includes extracted variables for a plurality of features. The different patient records have the same extracted features, but one or more patient records may have a fewer or greater number of features. Alternatively, one or more of the patient records includes information to be used for extracting features, such as including an image. Any format may be used for maintaining and storing the training data.

The memory 12 stores different types of classifiers and associated algorithms for training a classifier. Knowledge base or other information for training classifiers is also stored.

In another embodiment, the memory 12 stores one or more classifiers and corresponding variables for thresholds. The classifier includes the interaction of the thresholds for classification.

In another embodiment, the memory 12 stores a combination of training data, a bank of classifiers, and variables for thresholds. The system 10 is operable to implement determining the classifier by selection from a bank, constructing the classifier, or adjustment of a threshold as a function of a desired performance. The system 10 implements multiple approaches for a same current patient record to be analyzed.

The display 16 is a CRT, monitor, flat panel, LCD, projector, printer or other now known or later developed display device for outputting determined information. For example, the processor 12 causes the display 16 at a local or remote location to output data indicating a possible diagnosis, a probability associated with one or more possible diagnoses, an image with marked locations of interest, or other medical decision assistance associated with the current patient record. The output may be stored with or separate from the patient record. The performance associated with the classifier is also displayed.

The memory 14 stores instructions for the processor 12. In one embodiment, the instructions are stored on a removable media drive for reading by a medical diagnostic imaging system or a workstation. An imaging system or workstation uploads the instructions. In another embodiment, the instructions are stored in a remote location for transfer through a computer network or over telephone lines to the imaging system or workstation. In yet other embodiments, the instructions are stored within the imaging or assistance system on a hard drive, random access memory, cache memory, buffer, removable media or other device.

The processor 12 is programmed with and executes the instructions. The instructions are for adjusting performance in a medical decision support system. The functions, acts, methods or tasks illustrated in the figures or described herein are performed by the programmed processor 12 executing the instructions stored in the memory 14. The functions, acts, methods or tasks are independent of the particular type of instructions set, storage media, processor or processing strategy and may be performed by software, hardware, integrated circuits, film-ware, micro-code and the like, operating alone or in combination.

In one embodiment, the instructions are for obtaining a patient record for medical decision support analysis. Medical data, such as the patient record or portions of the patient record, is input to the processor 12 or the memory 14. The medical data is from one or more sources of patient information. For example, one or more medical images are input from ultrasound, MRI, nuclear medicine, x-ray, computer thermography, angiography, and/or other now known or later developed imaging modality. Additionally or alternatively, non-image medical data is input, such as clinical data collected over the course of a patient's treatment, patient history, family history, demographic information, billing code information, symptoms, age, genetics or other indicators of likelihood related to the abnormality or disease detection being performed. For example, whether a patient is female, has a personal history of breast cancer problems, has a detectable lump, has pain, has a family history of breast cancer or is old may indicate a likelihood of breast cancer. Other features may be used for breast cancer determination. The same and/or different features may be used for assisted diagnosis of other diseases.

The information is input by a user. For example, the instructions control a user interface to solicit entry of information manually by an operator. Alternatively or additionally, the information is extracted automatically, such as described in U.S. Publication Nos. 2003/0120458, 2003/0120133, 2003/0120134, 2003/0126101 or 2003/0130871, which are incorporated herein by reference. Information is automatically extracted from patient data records, such as both structured and un-structured records. Probability analysis may be performed as part of the extraction for verifying or eliminating any inconsistencies or errors. The system may automatically extract the information to provide some missing data. The processor 12 performs the extraction of information. Alternatively, other processors perform the extraction and input results, conclusions, probabilities or other data to the processors 12. Other automated extraction or importing of a patient record may be used, such as instructions for a routine to import patient record information from a structured database.

Instructions cause the processor 12 to display an option for setting performance. For example, a relative setting of sensitivity and specificity is displayed. As another example, a penalty table is displayed. As another example, a drop down or other menu provides for selection of a setting or settings. In another example, one or more areas for entry of specific numbers are provided with adjacent text indicating the relevant performance parameter. Any other display to solicit or make available performance setting may be used. In alternative or additional embodiments, the user enters a performance setting without a displayed option indicating the availability of setting performance.

Instructions cause the processor 12 to receive user input of specificity, sensitivity, specificity and sensitivity, or other performance. For example, the user adjusts an actual or virtual knob or slider to indicate a relative specificity and sensitivity setting. The signals generated by the user interface are generated and/or received by the processor 12.

Instructions cause the processor 12 to obtain a classifier as a function of the performance. More than one classifier may be obtained. In one embodiment, the classifier is selected from a collection of prior developed or previously trained classifiers. The prior developed classifiers have different performance attributes, such as different amounts of sensitivity and/or specificity. More than one classifier may be provided in the bank of classifiers for operating with different combinations of performance. One or more of the classifiers are selected based on the desired performance. The classifier with the best match to the desired performance with or without also considering other types of performance is selected.

In another embodiment, the processor 12 obtains the classifier by constructing the classifier from training data. The processor 12 selects a feature set included in the training set and the patient record to be diagnosed, selects a type of classifier and performs any other selections to train a classifier from the training set for analyzing the current patient record. The selections are part of a search pattern. Different combinations of selections and/or tuning may be used to build different classifiers in order to identify a classifier operable to meet the performance parameter. Any number of iterations for training may be used. The tuning may be limited by a number of attempts or change in performance as a function of the tuning. Knowledge base information may be used to lessen or limit the number of attempts to meet a desired performance. For example, the knowledge base may indicate feature sets, types of classifiers and/or tuning more likely to lead to a trained classifier meeting a particular performance setting. Other processes for selecting, training and tuning the classifier may be used.

In another embodiment, the processor determines one or more thresholds for the classifier as a function of the performance. A look-up table or programmed function relates a given performance to one or more thresholds. The thresholds applied by the classifier are set to provide the desired performance. Alternatively, the classifier or classifiers are applied to training data to identify threshold settings providing the desired performance. Other techniques for obtaining a classifier may be used.

The obtained classifier may be optimized. Using manual input or user feedback, the classifier is tuned. Alternatively, automatic optimization is performed. The obtained classifier provides the desired performance or better. Alternatively, the obtained classifier provides a closest available performance. Where the user inputs a performance setting for one parameter, the performance of other parameters may be requested from the user, set automatically or ignored. For example, the system requires a minimum level of performance for non-selected performance parameters. The non-selected performance parameters may be optimized as well to provide a highest or sufficient overall performance.

The instructions cause the processor 12 to apply the obtained classifier to the current patient record. The variables for the available features are input into the classifier. The current patient record is analyzed with the classifier. The classifier outputs diagnosis assistance for the current patient record, such as a binary indication, a probability, a location or other information.

Instructions may be provided for outputting an estimate of performance of the classifier. The estimate of performance is output with the output of the classifier or prior to any classifying of the current patient record. The estimate of performance may highlight areas of concern or reassure the operator or medical professional.

The instructions cause the processor 12 to repeat receiving, obtaining, and applying for a different patient record. To assist in diagnosis of a new patient, the same system 10 is used. A desired performance is determined and a classifier is obtained based on the desired performance. The same system 10 operates with different performance. A “one classifier fits all” approach may be avoided, providing versatility and possible better performance on a patient-by-patient, user-by-user, or facility-by-facility basis. The same training data or other data may be used by the system 10 to create different classifiers as appropriate for the different patient records. The training data may also be updated, such as a structured update or by accumulating some or all of the new patient records as part of the training data once an actual diagnosis or label is known.

FIG. 4 shows a method for adjusting performance in a medical decision support system. The method is implemented using the system 10 of FIG. 1 or a different system. Additional, different or fewer acts than shown in FIG. 4 may be provided. For example, acts 20 or 28 may not be performed. The acts are performed in the order shown or a different order. The acts may be performed automatically, manually, or combinations thereof. For example, all of the acts are performed automatically by a processor with tuning or input for act 22 being manual.

Some or all of the acts, such as acts 22, 24 and 26, are performed by a processor during use by an end-user, such as a clinician, of the medical support system. Rather than a designer creating different classifiers for purchase by end-users or associated facilities, the method provides for different performance by an end product without delays for purchasing a different classifier or without a one-fits all approach to classifying for a particular type of diagnosis. Rather than a purchaser having to purchase specific classifiers based on an expected need, the method provides for different performance based on a current need. Different classifier products may be provided, such as for different diseases. In alternative embodiments, a designer and/or purchases uses the method of FIG. 2.

Data for a new patient record is obtained. For example, the medical data is obtained automatically, through user input or a combination thereof for a particular patient being examined for diagnosis. The medical data is structured or unstructured.

In act 20, a performance option is displayed. For example, a list of performance parameters for selection is displayed. The performance parameters are a penalty table, sensitivity, specificity, a ROC curve, combinations thereof or other now known or later developed performance parameters. Settings for the performance parameters may be displayed, such as providing for selectable settings for one or more of the performance parameters. For example, a ROC curve is displayed and the user selects performance as a point along the curve. Alternatively, relative settings or a location for inputting a desired setting is provided.

In act 22, user input of a specificity, sensitivity or specificity and sensitivity related performance parameter is received. Related performance parameters include a penalty table, ROC curve position or other parameter associated with diagnostic performance of the classifier. To input both the sensitivity and specificity at the same time, the user selects a trade-off. Sensitivity and specificity are related to each other. The shape of the ROC curve determines the sensitivity at a given specificity or the specificity at a given sensitivity. Where different classifiers are available, the user may be able to input desired values for both sensitivity and specificity to identify a closest match. Alternatively, the user selects a desired value for one and treats the other as secondary or dictated by the selection of the desired value. The user input is provided locally or from a remote location. In one embodiment, the user input provides a specific specificity, sensitivity or both. In other embodiments, the user input provides a value or other setting used to derive desired performance, such as a relative setting (e.g., sensitivity in importance as compared to specificity).

The user input is received during assisted diagnosis. The clinician or physician inputs or adjusts the performance as desired for a current patient or diagnosis. The performance is altered during actual use of the system for diagnosis assistance. The diagnostic assistance with adjustable performance may be used to assist determination of future treatment of an actual patient. In alternative embodiments, the diagnostic assistance with adjustable performance is used for previously treated patients with already known outcomes and/or for design for future diagnosis.

During the assisted diagnosis, a classifier is determined as a function of the performance parameter in act 24. For example, the performance parameter sets a desired performance level, such as a specificity of 75%. The classifier satisfying the desired performance is determined, and classifiers not satisfying the performance parameter are not assigned. Any now known or later developed process for assigning may be used.

For a given classifier, a processor determines an estimate of performance of the classifier. The system may provide the sensitivity, specificity, an ROC curve, or some other estimate of the performance of the classifier to the user. For example, the estimate is determined by a table of performance estimates of selectable classifiers or thresholds. As another example, the estimate is determined by applying the constructed classifier to training data. A leave-one-out or another approach provides an indication of the performance of the classifier. Since each input patient's data is potentially being run through a different classifier, there is no one estimate of performance that can be published for the system. Alternatively, statistical performance for the system based on application of multiple classifiers is published.

The estimate is output, such as for the system or with each associated analysis of a current patient record. The estimate of performance may provide feedback as to whether the data collected from the patient is sufficient to label the patient with the system or automatically.

In one embodiment, the processor determines the classifier by selecting from a collection of at least two classifiers. A bank of classifiers, each with different performance, is constructed prior to use of the system. The user selects from one of several classifiers based on the performance desired. For example, selecting a particular performance is used to select a specific classifier. Each classifier can be optimized independently by design. Any number of options may be available to the user. For example, classifiers are provided for the most common performance levels for the type of diagnosis. Where none of the classifiers provide the desired performance, the user is prompted to again input performance or a best match is determined.

In another embodiment, the processor determines the classifier by constructing, during the assisted diagnosis, the classifier. The classifier is constructed to meet the performance parameter. Once the user selects the performance metrics to be used, the classifier is built on the fly. Where a different performance parameter is desired, a different classifier is constructed.

One or more training sets and different classifier options are available to construct the classifier. Building a classifier may include feature selection, determining the type of classifier to use, such as neural nets, support vector machines, or others, and tuning the classifier using the training data to optimize performance. The construction is automated or performed by the processor with no or some feedback or input from the user other than selection of the performance.

The processor selects features from training set patient records. Automated feature selection may be based on machine-learnt processes for feature selection and/or programmed identification. Alternatively, manual input assists in selection of features. The selected features may be limited by the features or a sub-set of features available for the current patient record. Rather than using all of the features of the training set patient records, features are selected based on the features available in the patient record to be classified. Unselected features are not used for training the classifier, but may be used.

The training set may contain incomplete information. Where one or more patient records of the training set do not include a feature available in the current patient record, these training set patient records are not used or are unselected. The classifier is built to use only those cases in the training set which have all of the features contained in the current patient record. Alternatively, the training set is updated or cleaned-up by filling in the missing data using actual data or substitute values. Alternatively, a classifier is built for operation with fewer than all of the available features of the current patient record.

After selecting the training set patient record information, the processor selects a type of classifier or other classifier parameters, such as a kernel or model. Any type of classifier may be assigned. Depending on the available features or desired performance, a single type of classifier may be available for selection or building. Alternatively, different types are available. The classifier is assigned from a support-vector machine (SVM), decision tree, neural net, Bayesian classifier, combinations thereof (e.g., hierarchal classification) or other now known or later developed type of classifier. Different classifiers may be used for different performance levels or in different iterative constructions since any specific problem may be more amenable to one classification approach over another.

The classifier is constructed as a classifier from the selected set of features from the training set patient records. The classifier is built with a single pass, or an iterative process is provided. Different combinations of some or all of the available features from the selected set are tried. Different types of classifiers or combinations of classifiers may be attempted. All possible combinations are attempted and the best performing one or ones are assigned. Alternatively, a first sufficiently performing classifier is assigned and no further classifiers are built. In other embodiments, the different combinations or iterations are guided logically or based on a knowledge base. Any possible tuning may be provided, such as manual tuning and/or automated tuning based on information in the training data. The classifier may be applied to the training data to determine performance for tuning.

Construction of the classifier is performed separately for different patient records to be analyzed. Alternatively, the construction is performed separately for each current patient record with different or sufficiently different desired performance.

The construction occurs as needed without requiring a user to generalize one classifier for all patient records to be analyzed. The user may not need to purchase a different classifier since the needed classifier is built or selected based on the desired performance. Additional classifier options or training data information may be purchased to alter the operation of the determination of the classifier or to provide more options.

In another embodiment, the processor determines the classifier by determining a threshold as a function of the performance parameter. The classifier outputs a likelihood or probability rather than a fixed label. For example, the classifier outputs the likelihood that a given candidate is cancer or not. A threshold is applied to the likelihood. For example, the threshold is 0.3, so the classifier labels any likelihood greater than 0.3 as cancer. By adjusting the threshold as a function of the desired performance, the classifier is determined with a desired performance. A correspondence between the threshold value and the desired performance, such as sensitivity and specificity pairs, is used. The desired performance determines the threshold level. For example, the ROC points are matched to threshold values. The threshold may be easily adjusted without changing internal design of the classifier (the classifier parameters) or without the need for retraining.

Different classifiers may correspond to different feature sets. Where a current patient record does not include one or more clinical features to be input into the classifier satisfying the performance, the user is requested to input the missing feature. For example, the user is asked to obtain and input test results or other medical information into the patient medical record. Alternatively, the missing feature is determined as a probability, a statistical analysis or other substitute information based on the training data, studies or other information. For image based classification, the features are automatically extracted from the image, so a common feature set may be provided without further user input.

In act 26, the determined classifier classifies the patient record with all or some of the available features of the current patient record. For the current patient, features are extracted from the patient record. Where some information is not available, some features may not be extracted. A processor automatically applies the classifier during the assisted diagnosis to classify between a normal state and one or more disease states. The disease states represent all possible disease states but may alternatively represent fewer than all possible disease states. The classification may be between a group of two or more states and another group of two or more states. Probabilities may be determined, such as determining a likelihood of a particular diagnosis. Where a likelihood threshold is used, the threshold is applied to the likelihood. The classification is performed with neural network, filter, algorithm, or other now-known or later developed classifier or classification technique. The classifier is configured or trained for distinguishing between the desired states.

In act 28, the receiving act 22 and determining act 24 are repeated during the assisted diagnosis. For example, the user views the performance of the determined classifier before or after performing classification in act 26. As another example, the user views the output of the classifier after act 26. In another example, the user acts without viewing the performance or output. The user resets the performance during the assisted diagnosis. The reset performance is received in act 22 and used to determine another classifier in act 24. The user optimizes the application of the classifier to a current patient record by repeating.

In other embodiments, the acts are repeated for different assisted diagnosis sessions, such as resetting the performance for different patient records or a same record at different times. Alternatively, the acts are repeated during the same assisted diagnosis, but for different users attempting to diagnosis a same patient record. The acts may be repeated for any reason, such as repeating only when new standards are provided.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1. A method for adjusting performance in a medical decision support system, the method comprising:
receiving, during assisted diagnosis, user input of a specificity, sensitivity or specificity and sensitivity related performance parameter;
determining, during the assisted diagnosis, a classifier as a function of the performance parameter; and
applying the classifier during the assisted diagnosis.

2. The method of claim 1 wherein receiving, determining and applying are performed by a processor during use by an end-user of the medical support system.

3. The method of claim 1 wherein determining comprises determining the classifier as a first option satisfying the performance parameter and not assigning a different classifier as a second option not satisfying the performance parameter.

4. The method of claim 1 wherein receiving comprises receiving a user selected specificity, sensitivity or specificity and sensitivity.

5. The method of claim 1 wherein determining comprises selecting from a collection of at least two classifiers, each of the at least two classifiers having a different performance parameter.

6. The method of claim 1 wherein determining comprises constructing, during the assisted diagnosis, the classifier, the classifier operable to meet the performance parameter.

7. The method of claim 6 wherein constructing is performed separately for different values of the performance parameter, and wherein the constructing is performed with a training set and a plurality of available classifier options.

8. The method of claim 1 wherein determining comprises determining a threshold for the classifier as a function of the performance parameter.

9. The method of claim 8 wherein applying comprises determining a likelihood of a particular diagnosis, the threshold being applied to the likelihood.

10. The method of claim 1 further comprising:
repeating the receiving and determining during the assisted diagnosis, the repetition corresponding to user optimizing the application of the classifier.

11. The method of claim 1 further comprising:
displaying a list of available performance parameters for selection.

12. The method of claim 1 wherein receiving comprises receiving the user input of a relative setting of specificity to sensitivity.

13. In a computer readable storage media having stored therein data representing instructions executable by a programmed processor for adjusting performance in a medical decision support system, the storage media comprising instructions for:
displaying an option for setting performance;
receiving user input of a specificity, sensitivity or specificity and sensitivity related performance;
obtaining a classifier as a function of the performance; and
applying the classifier.

14. The instructions of claim 13 wherein obtaining comprises selecting from a collection of at least two classifiers, each of the at least two classifiers having a different performance.

15. The instructions of claim 13 wherein obtaining comprises constructing the classifier from a training set, the classifier operable to meet the performance parameter, and wherein applying comprises applying the classifier to a patient record for diagnosis assistance.

16. The instructions of claim 13 wherein obtaining comprises determining a threshold for the classifier as a function of the performance.

17. The instructions of claim 13 further comprising:
repeating the receiving, obtaining and applying for diagnosis assistance for a different patient.

18. The instructions of claim 13 wherein displaying comprises displaying a relative setting of sensitivity and specificity, and wherein receiving comprises receiving the user input of the relative setting of specificity and sensitivity.

19. A system for adjusting performance in a medical decision support, the system comprising:
a user input operable to receive different performance settings at different times; and
a processor operable to determine a first classifier as a function of a first performance setting, operable to determine a second classifier as a function of a second performance setting and operable to determine a first diagnosis with the first classifier and a second diagnosis with the second classifier, the processor being part of a medical decision support system.

20. The system of claim 19 wherein the user input is operable to receive the different performance settings at different times during a same diagnosis session for a same patient, and wherein the processor is operable to determine the first and second classifiers during the diagnosis session for the patient.

21. The system of claim 19 wherein the user input is operable to receive the different performance settings for different patients, and wherein the processor is operable to determine the first and second classifiers for the different patients.

22. The system of claim 19 wherein the processor is operable to determine the first and second classifiers by selecting from a collection of at least two classifiers, each of the at least two classifiers having a different performance.

23. The system of claim 19 wherein the processor is operable to construct the first and second classifiers from a training set, the first and second classifiers operable to meet the first and second performance settings, respectively.

24. The system of claim 19 wherein the processor is operable to determine first and second thresholds for the first and second classifiers, respectively, as a function of the first and second performance settings.

25. The system of claim 19 wherein the user input is operable to receive a relative setting of sensitivity and specificity, the performance setting comprising the relative setting.
